(19) United States
(12) Patent Application Publication
(10) Pub. No.: US 2024/0013066 A1
(43) Pub. Date: Jan. 11, 2024

(54) MULTI-STAGE KNOWLEDGE GRAPH CONSTRUCTION USING MODELS

(71) Applicant: INTERNATIONAL BUSINESS MACHINES CORPORATION, ARMONK, NY (US)

(72) Inventors: Igor Melnyk, White Plains, NY (US); Pierre L. Dognin, White Plains, NY (US); Payel Das, Yorktown Heights, NY (US)

(21) Appl. No.: 17/811,338

(22) Filed: Jul. 8, 2022

(51) Int. Cl. G06N 5/02

(52) U.S. Cl. CPC G06N 5/022

(57) ABSTRACT

A knowledge graph is constructed as part of a multi-stage process using pretrained language models. Input text in a natural language format is received. In a first stage, a plurality of nodes is generated using a pretrained language model, where the nodes correspond to entities of the input text. In the second stage edges to interconnect the plurality of nodes are generated. The edges are generated responsive to generating each of the plurality of nodes.

### BACKGROUND

Knowledge graphs are data constructs that represent (and store data regarding) entities and the relationships therebetween. Knowledge graphs are typically generated in a graphical format, often thereafter stored in a graph database. Further, data scientists are finding increasing utility in knowledge graphs, as they are a way of storing data that is uniquely useful and understandable to both humans and computers. As such, many powerful applications (e.g., such as question-answering applications, reasoning applications, decision-making applications, and the like) utilize knowledge graphs. Given the increasing amount of data that exists (and the increasing rate at which this data is being generated) and the increasing awareness that this growing data would be useful to various applications, there are increasing efforts to streamline the process of generating knowledge graphs, where these efforts dovetail with similar efforts to increase the repeatable accuracy of generated knowledge graphs.

### SUMMARY

Aspects of the present disclosure relate to a method, system, and computer program product relating to multi-stage knowledge graph construction using pretrained language models. For example, the method includes receiving input text in a natural language format. The method also includes generating a plurality of nodes corresponding to entities of the input text. The method also includes generating edges to interconnect the plurality of nodes responsive to generating each of the plurality of nodes. A system and computer program configured to execute the method described above are also described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which controller may construct knowledge graphs in a multi-stage format using pretrained language models.

FIGS. 2A-2D depict different stages of knowledge graph construction using various pretrained language models.

FIG. 3 depicts a conceptual box diagram of example components of the controller of FIG. 1.

FIG. 4 depicts an example flowchart by which the controller of FIG. 1 constructs knowledge graphs using pretrained language models.

FIG. 5 depicts results from experiments of implementations of aspects of this disclosure as compared to conventional systems and techniques for constructing knowledge graphs.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to automatically constructed knowledge graphs, while more particular aspects of the present disclosure relate to constructing knowledge graphs in a multi-stage process using pretrained language models. While the present disclosure is not necessarily limited to such applications, various aspects of the disclosure may be appreciated through a discussion of various examples using this context.

As the utility and ubiquity of knowledge graphs grow, so does the desire to improve the ease by which knowledge graphs may be constructed. While some efforts are directed to improving technologies by which a knowledge graph may be manually created, a significant amount of effort is going to improving the ability with which knowledge graphs (KGs) are constructed automatically, where “automatically” as used herein means autonomously (e.g., without input from or direct supervision by humans). This often refers to the act of converting bodies of natural language text into knowledge graphs, whether these bodies contain electronic documents that already have significant natural language metadata attached to them, or these bodies of natural language are received in a completely unstructured graphical format (e.g., scanned version of handwritten notes) and have to be pre-processed (e.g., run through optical-character recognition (OCR)) prior to KG construction.

Once these KGs are constructed, they are used for numerous types of downstream applications, such as reasoning applications (e.g., where the KG helps a computer system determine data-backed operations for a system), decision-making applications (e.g., where a KG helps a computer system that is configured to interface with a human that is looking to make a decision, such as a doctor interacting with a computer system in trying to decide how to medically treat a patient given certain characteristics and conditions of the patient), question-answering applications (e.g., where a computing system uses KGs to determine appropriate and accurate answers for questions from a user), or the like. For each of these applications, the computer system performs better (e.g., is more accurate across a broader breadth of subjects) the better the KG is, where a KG is “better” when it has accurate relationships (as defined by respective edges) between relevant nodes and the nodes capture the relevant entities for a situation.

Conventional KG constructing techniques typically include analyzing natural language text in order to determine both nodes and edges in parallel and/or simultaneous determinations. For example, conventional KG construction techniques may analyze a word, and then determine whether that word is to be represented by a node and also determine what other nodes the word is to be connected to via edges in a single determination operation. This often includes “linearizing” the natural language data, where all nodes are lined up according to relationships, after which edges are applied according to these relationships, after which the nodes are graphically “spread out.” In this way, the process of constructing nodes and edges functionally happens during a single stage. As a result of such a process, conventional KG construction techniques struggle to construct unique KGs when presented with atypical situations and nuanced relationships, as the linear approach tends to “flatten” the constructed KG.

Further, systems that tend to have the most need for accurate and robust KGs tend to be the systems with the most atypical and nuanced relationships. For example, humans may not have as much need for a powerful decision-making application for situations where there are obvious relationships with bright line rules and causations. As such, the failure of conventional KG-construction solutions to construct KGs that reliably capture and reflect complex and nuanced situations is exacerbated given that such situations are the areas where KGs are most coveted.

In many conventional computing solutions, one avenue to improvement is continued training, such as machine learning (ML) training. Training tends to be most effective when it is highly targeted. For example, executing a training operation of a single module that does a single concrete task is often more effective than trying to train a full algorithm that executes a significant number of tasks. This is because for more sizeable processes there is more noise, and it is therefore more difficult to identify what is the variable to be changed in order to arrive at better results. However, given that conventional KG construction techniques tend to generate nodes and edges in (what is functionally) a single process, improving results via training has somewhat limited returns (e.g., as it can be difficult to determine if a shortcoming of a final KG is more the cause of node generation or edge generation or a combination of the two).

Aspects of this disclosure solve or otherwise address the technical shortcomings of conventional KG-construction solutions. For example, aspects of this disclosure relate to split generation into two steps, where a first step uses pretrained language models to generate nodes and the second step uses obtained node information to generate edges. One or more computing devices that include one or more processing units executing instructions stored on one or more memories may provide the functionality that addresses these problems, where said computing device(s) are herein referred to as a controller. As a result of splitting this process into multiple steps, the controller is able to create nuanced and highly tailored KGs that perform excellently against conventional KGs. Further, as a result of splitting the steps of generating nodes and generating edges into a multi-stage methodology, aspects of this disclosure improve a trainability of the full process by enabling each of these stages to be evaluated and trained separately.

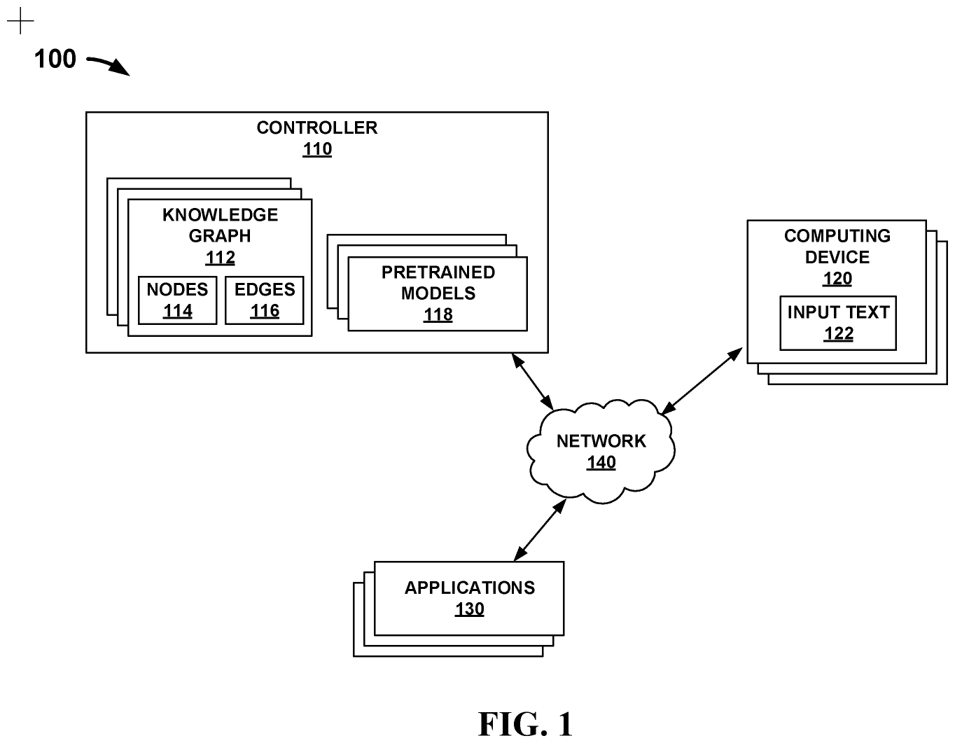

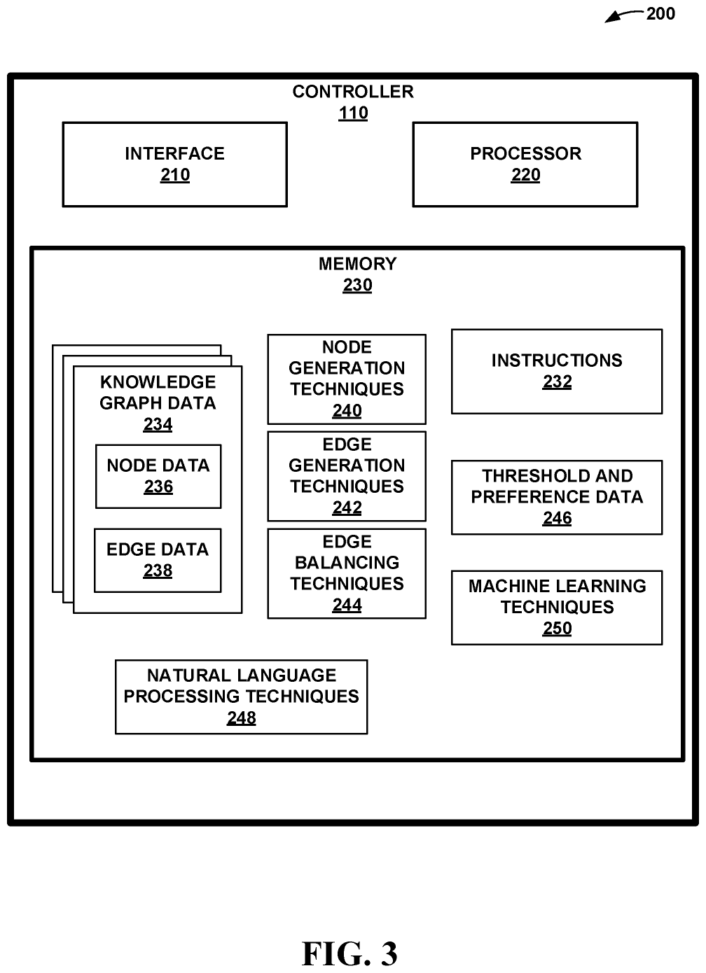

For example, FIG. 1 depicts environment 100 in which controller 110 constructs knowledge graphs 112 (also referred to interchangeably as KGs 112). Controller 110 may include a processor coupled to a memory (as depicted in FIG. 3) that stores instructions that cause controller 110 to execute the operations discussed herein. Controller 110 generates KGs 112 from natural language input text 122 as generated and/or stored on computing devices 120. Input text 122 may be text stored in a natural language format in any language. Input text 122 can be relatively small (e.g., a single sentence, or a single paragraph, or a single article), or input text 122 can be relatively substantial (e.g., a corpus of hundreds or thousands of documents). In some examples input text 122 may be electronic documents that have significant amounts of metadata attached (e.g., where each character is identified, words are identified, punctuation is tagged, etc.), whereas in other examples input text 122 is stored on computing device 120 in an unstructured format (e.g., as a scanned copy of a person's handwriting) such that controller 110 uses natural language processing (NLP) techniques such as optical character recognition (OCR) to identify the natural language of the input text 122.

Once controller 110 constructs KGs 112, these are used in various applications 130. For example, controller 110 may construct KGs that are used for artificial intelligence (AI) applications 130, such as customer-facing AI applications 130 or back-end AI applications 130. Examples of such applications 130 include QA applications, decision making applications, reasoning applications, or the like. Incidentally, though controller 110 is depicted as being structurally distinct from components such as applications 130 and computing devices 120, in some embodiments some or all of these components could be integrated into controller 110. For example, controller 110 could both construct KGs 112 and also provide some or all functionality of applications 130 using KGs 112.

However, in examples where controller 110 is structurally distinct from other components of environment 100 as depicted in FIG. 1, controller 110 may be able to communicate with these different components over network 140. Network 140 may include a computing network over which computing messages may be sent and/or received. For example, network 140 may include the Internet, a local area network (LAN), a wide area network (WAN), a wireless network such as a wireless LAN (WLAN), or the like. Network 140 may comprise copper transmission cables, optical transmission fibers, wireless transmission, routers, firewalls, switches, gateway computers and/or edge servers. A network adapter card or network interface in each computing/processing device (e.g., computing devices 120, as well as computing devices that host/include controller 110 and applications 130) may receive messages and/or instructions from and/or through network 140 and forward the messages and/or instructions for storage or execution or the like to a respective memory or processor of the respective computing/processing device. Though network 140 is depicted as a single entity in FIG. 1 for purposes of illustration, in other examples network 140 may include a plurality of private and/or public networks.

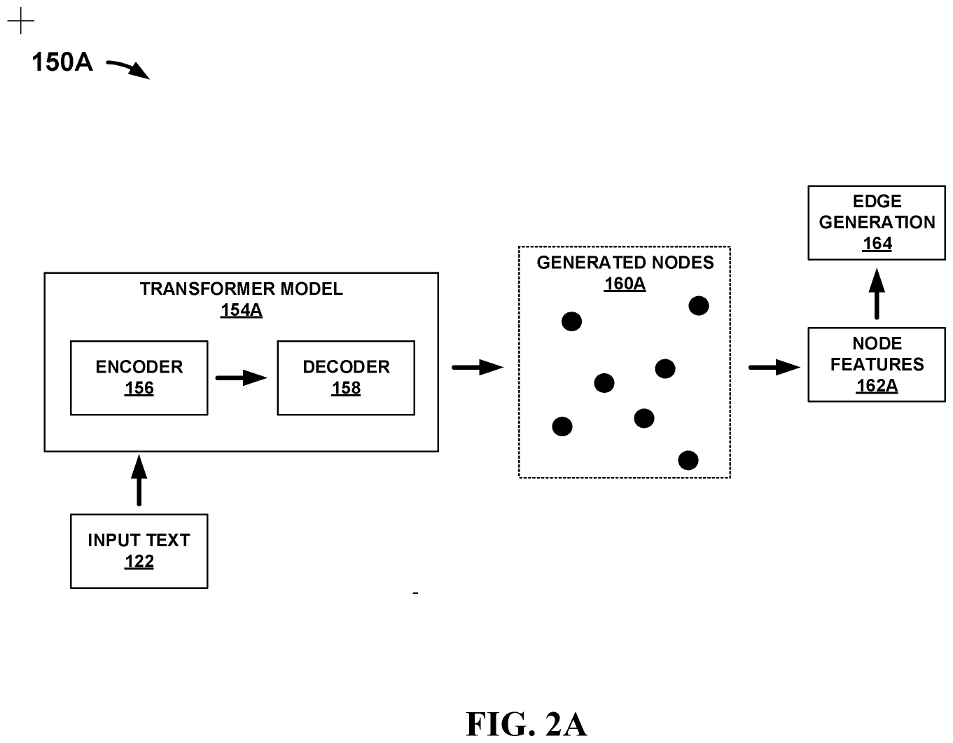

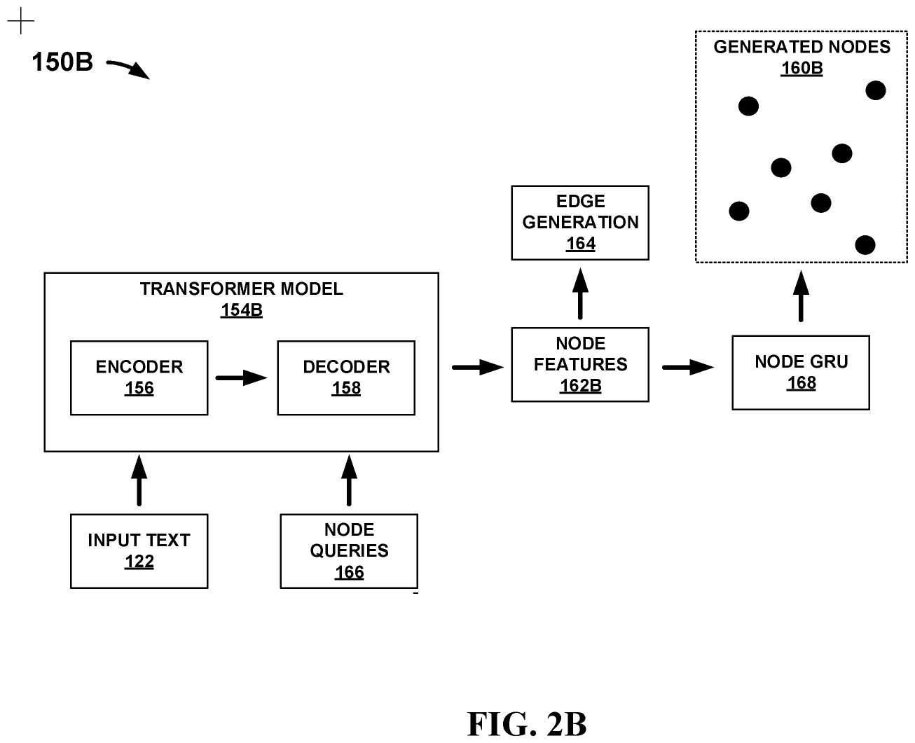

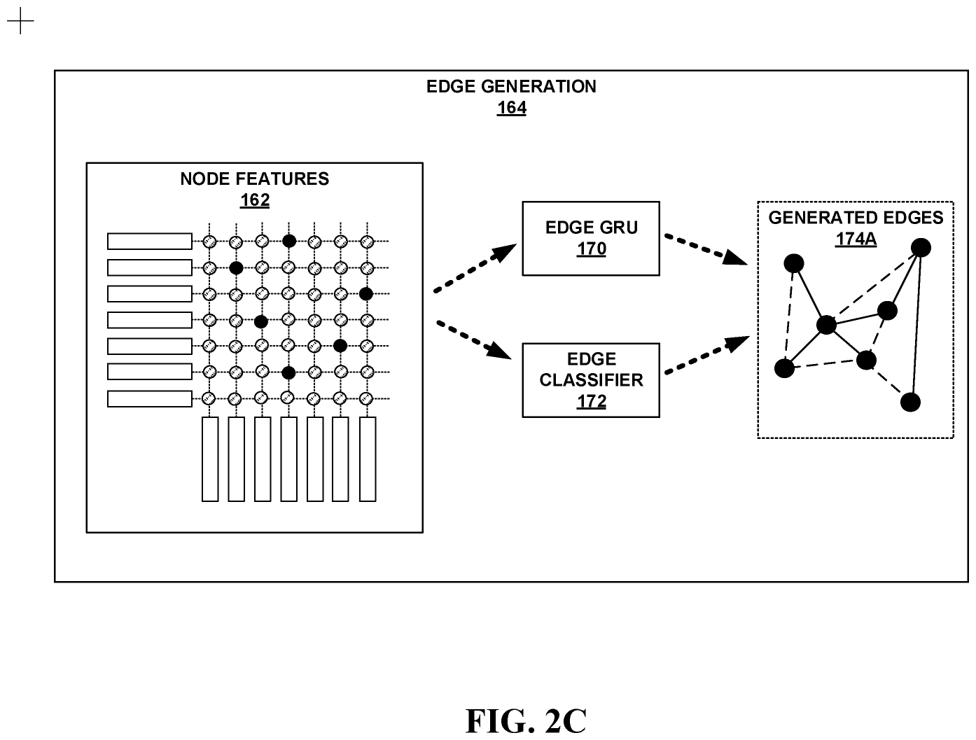

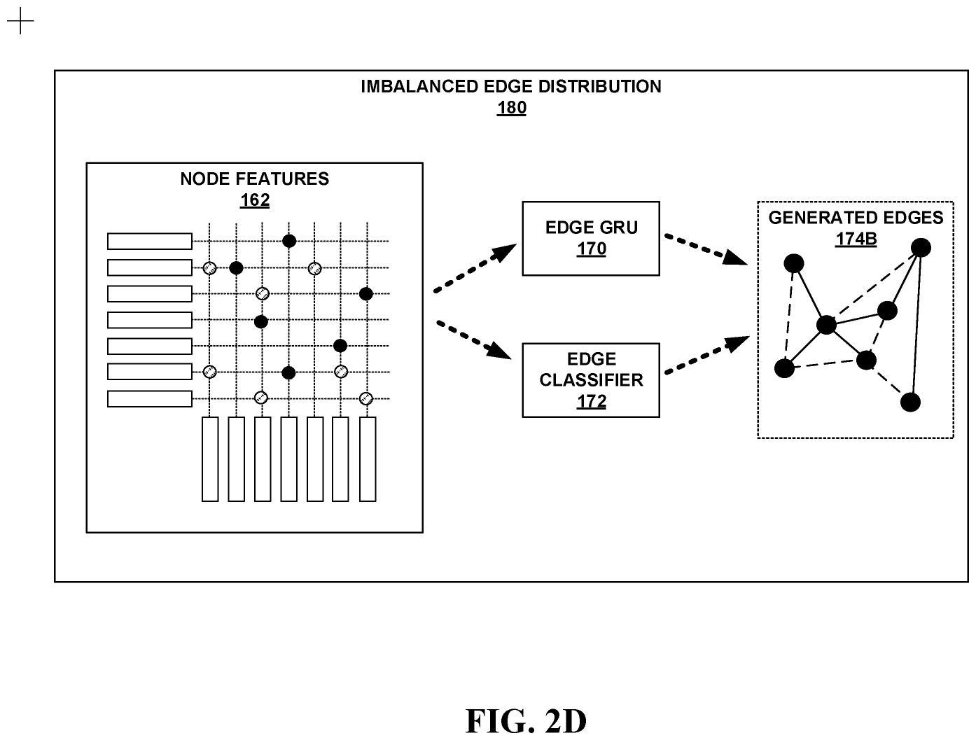

As discussed, controller 110 constructs KGs 112 in a multi-stage process, where one stage relates to the generation of nodes 114 and another stage relates to the generation of edges 116. Further, controller 110 may generate nodes 114 via one or more pretrained language models 118, hereinafter referred to as pretrained models 118. For example, controller 110 may generate nodes 114 with an encoder-decoder pretrained model 118, such as a T5 encoder-model. FIGS. 2A-2D depict example logistical flowcharts by which controller 110 may generate nodes 114 and edges 116.

For example, FIG. 2A depicts flowchart 150A by which controller 110 may generate nodes 114 and edges 116 in a multi-stage process. As depicted in FIG. 2A, controller 110 generates nodes using a sequence-to-sequence paradigm utilizing pretrained model 118 of T5 model 154A that includes both encoder and decoder 158. Controller 110 may provide input text 122 to T5 model 154A, in order to create generated nodes 160A, where generated nodes 160A may relate to entities of input text 122. The number and arrangement of nodes within generated nodes 160A is provided for purposes of illustration only, as any number of nodes in any arrangement are provided in other examples.

For example, controller 110 may fine tune T5 model 154A in translating input text 122 into generated nodes 160A using a formula such as:

<PAD>NODE₁<NODE_SEP>NODE₂<NODE_SEP> . . . NODE_{N}<NODE_SEP>

where this formula generates nodes 1 through N of generated nodes 160A. Further, <NODE_SEP> refers to the steps of delineating node boundaries and extracting hidden states of nodes. Using this data extracted from input text 122, controller 110 may use techniques known to one of ordinary skill in the art to further extract node features 162A, where these node features 162A are then submitted to the next stage in the multi-stage process (where this stage is edge generation 164).

Conversely, FIG. 2B depicts an alternative way by which controller 110 may use pretrained models 118 to generate nodes 114 using node queries 166. For example, as depicted in FIG. 2B, T5 Model 154B may be slightly different than T5 model 154A in that T5 Model 154B is configured to have decoder 158 receive an input of learnable node queries (e.g., learned query vectors from an embedding matrix) in addition to input text 122. T5 Model 154B may be configured to disable causal masking to account for all of node queries 166. From here, controller 110 may determine the set of node features 162B directly as the output from decoder 158, where these node features 162B are sent to edge generation 164 step as in FIG. 2A.

Further, controller 110 may send generated node features 162B to node gated recurrent unit (GRU) 168, and cause node GRU 168 to compile generated nodes 160B. Controller 110 may cause node GRU 168 to compile generated nodes 160B via a permutation-invariance of the nodes, where nodes are target-aligned using bipartite matching and cross-entropy is used as the matching cost.

Beyond this, FIG. 2C depict an example flowchart of edge generation 164 process. As depicted, controller 110 may start with the determined node features 162, where node features 162 includes either of node features 162A or node features 162B (e.g., such that node features 162 is the genus and node features 162A, 162B are two species). In some examples, as depicted, controller 110 may arrange node features 162 in a graphical format, where nodes are represented by bars along an outside and dots within bars have a first graphical identifier (e.g., filled in as depicted in FIG. 2C) to indicate a relationship between the respective nodes, and dots within the bars have a second graphical identifier (e.g., hatched as depicted in FIG. 2C) to indicate a lack of a relationship between the respective nodes. While only two graphical identifiers are provided in FIG. 2C, in other examples there may be more than two graphical identifiers, and/or something other than graphical identifiers may be used to identify relationships.

From here, these node features 162 are fed to either an edge GRU 170 or an edge classifier 172. The edge GRU 170 may be more robust and therefore able to construct relatively more edge sequences, whereas conversely edges generated with the edge GRU 170 may carry a risk of not matching a desired/target edged sequence with a desired amount of accuracy and/or repeatability. Conversely, edge classifier 172 may be relatively more efficient and accurate where the edge estimate is static/fixed, whereas edge classifier 172 may be prone to misclassifying if there is a limited coverage of the possible edges. From here, controller 110 may compile generated edges 174A.

Once edges 116 are generated, controller 110 may evaluate the balance of edges 116. For example, if the number of actual edges 116 within generated edges 174A is relatively small, and <NO_EDGE> is large (e.g., where <NO_EDGE> is the manner in which controller 110 stores and/or reflects dots of node features 162 that indicate that no relationship are present and therefore no edge is to be constructed between the respective nodes 114), edges 116 may be imbalanced. Where edges 116 are imbalanced, training may be harder, such that it may be difficult to improve/fine-tune pretrained models 118 over time. Given that one advantage of a multi-stage KG construction process is the increased ability to train the ML models throughout, it is advantageous to balance edges to take advantage of this increased ability to train.

For example, controller 110 may balance edges 116 via a focal loss technique. For example, controller 110 may replace the traditional cross-entropy (CE) loss with focal loss. This may include controller 110 down-weighting (e.g., deemphasizing) CE for well-classified samples, and increasing CE loss for misclassified samples. This may be done with formulas such as:

CE(p,t)=−log(pₜ)

FL(p,t,λ)=−(1−pₜ)λ log(pₜ)

where λ≥0 is a weighting factor, and λ=0 makes both losses equivalent.

Conversely, as depicted in FIG. 2D, controller 110 may balance edges by “sparsifying” the adjacency matrix of node features 162. For example, controller 110 may modify training settings such that most of the <NO_EDGE> determinations are removed, such that the classes are re-balanced artificially. In some examples, this modification would only be for a training period to better teach the respective models, where the model outputs all edge results (e.g., including <NO_EDGE> outputs). In this way, training may experience no losses (such that the model will get better over time), even as the outputs are substantially unchanged (such that the model provides as good of output as it can at any given moment in time).

As described above, controller 110 may include or be part of a computing device that includes a processor configured to execute instructions stored on a memory to execute the techniques described herein. For example, FIG. 3 is a conceptual box diagram of such computing system 200 of controller 110. While controller 110 is depicted as a single entity (e.g., within a single housing) for the purposes of illustration, in other examples, controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with computing devices 120, applications 130, or the like. Interface 210 may include one or more network interface cards, such as Ethernet cards and/or any other types of interface devices that can send and receive information. Any suitable number of interfaces may be used to perform the described functions according to particular needs.

As discussed herein, controller 110 may be configured to construct knowledge graphs in a multi-stage process using pretrained language models. Controller 110 may utilize processor 220 to construct knowledge graphs in this way. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to construct knowledge graphs in this multi-stage process accordingly.

Processor 220 may construct knowledge graphs according to instructions 232 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may construct knowledge graphs as described herein according to instructions 232 of one or more applications (e.g., software applications) stored in memory 230 of controller 110.

In addition to instructions 232, in some examples gathered or predetermined data or techniques or the like as used by processor 220 to construct knowledge graphs as described herein may be stored within memory 230. For example, memory 230 may include information described above that is gathered from (and/or constructed within) environment 100. Specifically, as depicted in FIG. 3, memory 230 may include knowledge graph data 234, which may include the full graphical KG. For example, knowledge graph data 234 may node data 236 with the information on each entity, as well as edge data 238 defining the relationships between each of these identified entities.

Further, memory 230 may also include node generation techniques 240, edge generation techniques 242, and edge balancing techniques 244 as discussed herein. For example, node generation techniques 240 may include a sequence-to-sequence paradigm (e.g., as discussed with reference to FIG. 2A, where the methodology within FIG. 2A is hereinafter referred to as using text nodes or the text node methodology) or query vectors (e.g., as discussed with reference to FIG. 2B). For another example, edge generation techniques 244 may include GRU-based generation and a classifier-based edge generation. Further, edge balancing techniques 244 may include focal loss techniques as described herein and techniques involving sparsifying the adjacency matrix as discussed herein.

Further, memory 230 may include threshold and preference data 246. Threshold and preference data 246 may include thresholds that define a manner in which controller 110 is to manage constructing KGs in a multi-stage process. For example, threshold and preference data 246 may include preferences as to different situations in which controller picks different node generation techniques 240, edge generation techniques 242, edge balancing techniques 244, or the like. In some examples threshold and performance data 246 may be specific to various applications 130, such that controller 110 will use certain techniques (or use techniques with certain weights), whereas for a different application controller 110 may use a different technique.

Memory 230 may further include natural language processing (NLP) techniques 248. NLP techniques 248 can include, but are not limited to, semantic similarity, syntactic analysis, and ontological matching. For example, in some embodiments, processor 220 may be configured to analyze natural language data of input text 122 or the like as stored in computing device 120 to determine semantic features (e.g., word meanings, repeated words, keywords, etc.) and/or syntactic features (e.g., word structure, location of semantic features in headings, title, etc.) of natural language data within the provided input text 122. Ontological matching could be used to map semantic and/or syntactic features to a particular concept. The concept can then be used to identify explicit or implicit queues within audio data 236. For example, controller 110 may use NLP techniques 244 to determine a general topic of input text 122, and based on that topic determine what application 130 a constructed knowledge graph 122 would be used for, and based on this determination controller 110 may identify what node 114 and edge 116 generation techniques to use as discussed herein.

Memory 230 may further include machine learning techniques 250 that controller 110 may use to improve a process of constructing knowledge graphs as described herein over time. Machine learning techniques 250 can comprise algorithms or models that are generated by performing supervised, unsupervised, or semi-supervised training on a dataset, and subsequently applying the generated algorithm or model to construct knowledge graphs in a multi-stage process using pretrained language models as described herein. Using these machine learning techniques 248, controller 110 may improve an ability to construct nodes and edges in a way that is robust and representative of correlations within bodies of natural language texts. For example, controller 110 may identify over time which techniques are getting better results when applied in applications 130, and therein change which techniques are used for which subjects for which ontological subjects for which applications 130, and moreover which weights do a better job of determining the meaningful entities and/or relationships of input text 122.

Machine learning techniques 250 can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. Specifically, machine learning techniques 248 can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

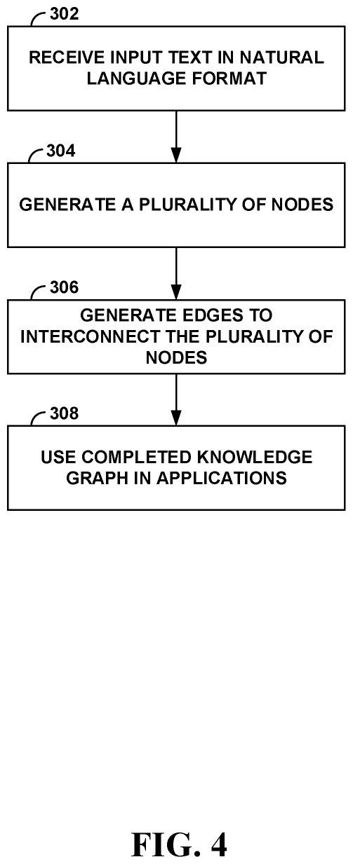

Using these components, controller 110 may construct knowledge graphs in a multi-stage process as discussed herein. For example, controller 110 may respond to construct knowledge graphs in a multi-stage process using pretrained language models according to flowchart 300 depicted in FIG. 4. Flowchart 300 of FIG. 4 is discussed with relation to FIG. 1 for purposes of illustration, though it is to be understood that other environments with other components may be used to execute flowchart 300 of FIG. 4 in other examples. Further, in some examples controller 110 may execute a different method than flowchart 300 of FIG. 4, or controller 110 may execute a similar method with more or less steps in a different order, or the like.

Controller 110 receives input text 122 in a natural language format (302). For example, controller 110 may gather or be sent a document (or a collection of documents) as generated and/or stored on computing device 120. In some examples, computing device 120 is a storage device and input text 122 is a significant repository of natural language data on a subject, such that controller 110 is tasks with created a relatively comprehensive KG on a particular subject on which input text 122 is focused.

Controller 110 generates a plurality of nodes 114 (304). Each of these nodes 114 may represent entities of an eventual KG 112. Controller 110 may generate these nodes 114 via a pretrained language model 118, such as a T5 model that makes use of encoder-decoder. For example, controller 110 may use a pretrained language model that itself uses the text node process as described herein (e.g., a sequence-to-sequence paradigm where node features are identified from the plurality of nodes and the edges are generated (306) using the node features as discussed with relation to FIG. 2A). For another example, controller 110 may generate nodes 114 using a model in which the decoder receives input of learnable node queries and the decoder directly outputs node feature (e.g., wherein the edges are again generated (306) using the node features).

Controller 110 generates edges 116 to interconnect the plurality of nodes 114 (306). Controller 110 may generate edges 116 using GRU techniques and/or classification based techniques. In some examples, edges 116 are balanced within this process. For example, edges 116 may be selected by down-weighting cross-entropy loss for well-classified samples and increasing cross-entropy for misclassified samples within input text 122. In examples where language models are trained to generate edges 116, controller 110 may training the language models by sparsifying an adjacency matrix used to select edges 116.

Controller 110 applies the KG in applications 130. For example, controller 110 uses the KG to provide an answer to a user device, where application 130 is a QA application. For another example, controller 110 uses KG to evaluate between various options to assist a user in making a decision in a decision-making application 130. For example, controller 110 may evaluate associations between KG and characteristics of a query from a user to provide relevant data (as located via KG 112) in recommending a decision.

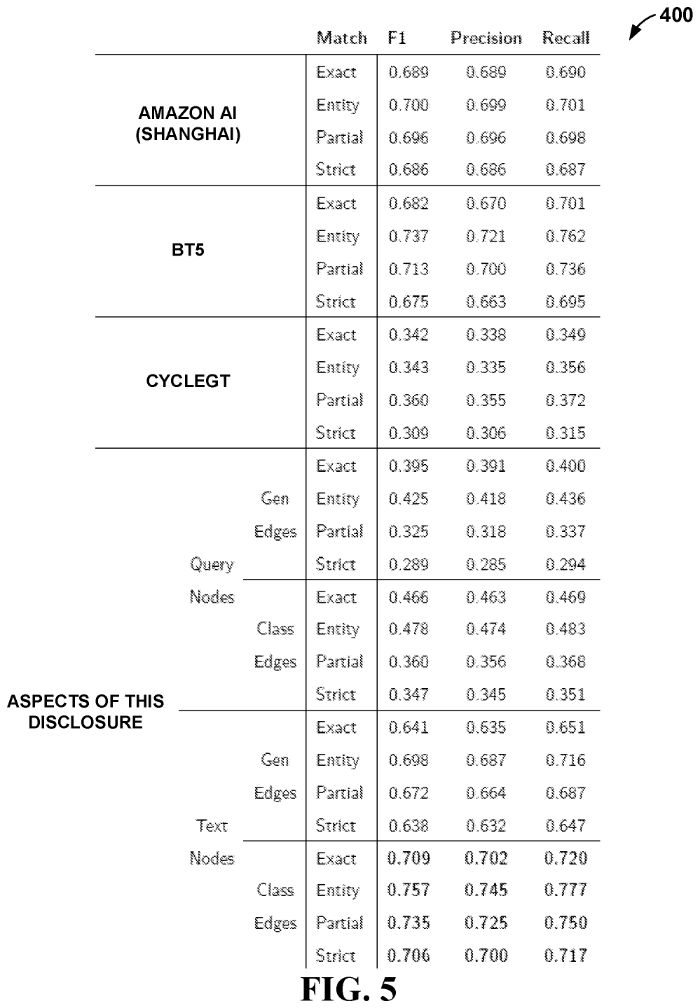

FIG. 5 depicts example results 400 of an experiment regarding aspects of this disclosure as it compares to various conventional techniques for constructing knowledge graphs. For example, aspects of this disclosure relate to using query nodes or text nodes to generate nodes, and thereinafter using classification techniques or GRU techniques to generate edges. This is compared to using conventional techniques such as those provided by Amazon AI (Shanghai), BT5 technologies, and CycleGT. This experiment was used using WebNLG+2020 data on a text to resource description framework (RDF) task, where there were 13,211 RDF triple sets available for training, 1,667 available for development, and 752 available for testing, while there were 35,426 texts available for training, 4,464 available for development, and 2,155 available for testing. As depicted, aspects of this disclosure outperformed all conventional methodologies. For example, generating nodes with text nodes while generating edges with classification as described herein performed better than conventional methodologies.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving input text in a natural language format;
generating a plurality of nodes corresponding to entities of the input text; and
generating edges to interconnect the plurality of nodes responsive to generating each of the plurality of nodes.

2. The computer-implemented method of claim 1, wherein the plurality of nodes is generated using a pretrained language model.

3. The computer-implemented method of claim 2, wherein the pretrained language model includes an encoder and a decoder of transformer model.

4. The computer-implemented method of claim 3, wherein the pretrained language model uses a text node methodology such that:
node features are identified from the plurality of nodes; and
the edges are generated using the node features.

5. The computer-implemented method of claim 3, wherein:
the decoder receives input of learnable node queries;
the decoder directly outputs node features; and
the edges are generated using the node features.

6. The computer-implemented method of claim 1, wherein the edges are generated using gated recurrent unit (GRU) techniques.

7. The computer-implemented method of claim 1, wherein the edges are generated using classification-based techniques.

8. The computer-implemented method of claim 1, wherein the edges are selected by down-weighting cross-entropy loss for well-classified samples and increasing cross-entropy for misclassified samples within the input text.

9. The computer-implemented method of claim 1, wherein language models are trained to generate the edges, the computer-implemented method further comprising training the language models by sparsifying an adjacency matrix used to select the edges.

10. A system comprising:
a processor; and
a memory in communication with the processor, the memory containing instructions that, when executed by the processor, cause the processor to:
receive input text in a natural language format;
generate a plurality of nodes corresponding to entities of the input text; and
generate edges to interconnect the plurality of nodes responsive to generating each of the plurality of nodes.

11. The system of claim 10, wherein the plurality of nodes is generated using a pretrained language model.

12. The system of claim 11, wherein the pretrained language model includes an encoder and a decoder of transformer model.

13. The system of claim 12, wherein the pretrained language model uses a text node methodology such that:
node features are identified from the plurality of nodes; and
the edges are generated using the node features.

14. The system of claim 12, wherein:
the decoder receives input of learnable node queries;
the decoder directly outputs node features; and
the edges are generated using the node features.

15. The system of claim 10, wherein the edges are generated using gated recurrent unit (GRU) technique.

16. The system of claim 10, wherein the edges are created using classification-based techniques.

17. A computer program product, the computer program product comprising a computer readable storage medium having program instructions embodied therewith, the program instructions executable by a computer to cause the computer to:
receive input text in a natural language format;
generate a plurality of nodes corresponding to entities of the input text; and
generate edges to interconnect the plurality of nodes responsive to generating each of the plurality of nodes.

18. The computer program product of claim 17, wherein the plurality of nodes is generated using a pretrained language model that includes an encoder and a decoder of transformer model.

19. The computer program product of claim 18, wherein the pretrained language model uses a text node methodology such that:
node features are identified from the plurality of nodes; and
the edges are generated using the node features.

20. The computer program product of claim 18, wherein:
the decoder receives input of learnable node queries;
the decoder directly outputs node features; and
the edges are generated using the node features.
